(19) United States
(12) Patent Application Publication
(10) Pub. No.: US 2024/0051621 A1
(43) Pub. Date: Feb. 15, 2024

(54) RECTIFYING DEVICE

(71) Applicant: KABUSHIKI KAISHA TOKAI-RIKA-DENKI-SEISAKUSHO, Niwa-gun (JP)

(72) Inventors: Daisuke NAKAYAMA, Aichi (JP); Nobuhiro KUDO, Aichi (JP); Kazuyuki YOKOYAMA, Aichi (JP)

(21) Appl. No.: 18/446,112

(22) Filed: Aug. 8, 2023

(30) Foreign Application Priority Data
Aug. 9, 2022 (JP) 2022-127472

(51) Int. Cl. B62D 35/00; B60S 1/66

(52) U.S. Cl. CPC B62D 35/005; B60S 1/66

(57) ABSTRACT

In a rectifying device, an actuator is operated to rotate a deflector, Here, a heater on an inner peripheral surface of the deflector is operated to generate heat, so that a periphery of the deflector is heated. Therefore, freezing around the deflector can be melted.

### CROSS-REFERENCE TO RELATED APPLICATION

This application is based on and claims priority under 35 USC 119 from Japanese Patent Application No. 2022-127472 filed on Aug. 9, 2022, the disclosure of which is incorporated by reference herein.

### BACKGROUND

### Technical Field

The present invention relates to a rectifying device that suppresses an air flow to a front wheel of a vehicle.

### Related Art

In a vehicle flow rectifying device described in JP 2019-93785 A, a flow rectifying member is rotated between a storage position and a flow rectifying position.

In such a vehicle flow rectifying device, it is preferable that freezing around the flow rectifying member can be melted.

### SUMMARY

In view of the above fact, an object of the present invention is to obtain a rectifying device capable of melting freezing around a rectifying body.

A rectifying device according to a first aspect of the present invention includes: a rectifying body that is moved in a deployment direction to be deployed on a front side of a front wheel of a vehicle, to suppress an air flow to the front wheel, and that is moved in a housing direction to be housed in a vehicle body; and a heating mechanism that is operated to heat a periphery of the rectifying body.

In the rectifying device of the first aspect of the present invention, the rectifying body is moved in the deployment direction to be deployed on the front side of the front wheel of the vehicle, to suppress the air flow to the front wheel. Furthermore, when the rectifying body is moved in the housing direction, the rectifying body is housed in the vehicle body.

Here, the heating mechanism is operated to heat the periphery of the rectifying body. Therefore, freezing around the rectifying body can be melted.

A second aspect of the present invention is the rectifying device according to the first aspect of the present invention, in which the heating mechanism is operated to heat the rectifying body.

In the rectifying device of the second aspect of the present invention, the heating mechanism is operated to heat the rectifying body. Therefore, the periphery of the rectifying body can be heated.

A rectifying device according to a third aspect of the present invention includes, in the rectifying device according to the first aspect or the second aspect of the present invention, a covering member that covers a lower side of the vehicle body, is provided with a deployment hole in which the rectifying body is deployed, and heats between the rectifying body and a peripheral surface of the deployment hole by operating the heating mechanism.

In the rectifying device of the third aspect of the present invention, the covering member covers the lower side of the vehicle body, and the rectifying body is deployed from the deployment hole of the covering member.

Here, the heating mechanism is operated to heat between the rectifying body and the peripheral surface of the deployment hole. Therefore, freezing between the rectifying body and the peripheral surface of the deployment hole can be melted.

A fourth aspect of the present invention is the rectifying device according to the third aspect of the present invention, in which the heating mechanism is operated to heat the covering member.

In the rectifying device of the fourth aspect of the present invention, the heating mechanism is operated to heat the covering member. Therefore, it is possible to heat a space between the rectifying body and the peripheral surface of the deployment hole.

A rectifying device according to a fifth aspect of the present invention is the rectifying device according to any one of the first to fourth aspects of the present invention, in which the heating mechanism is operated to inject a fluid around the rectifying body.

In the rectifying device of the fifth aspect of the present invention, the heating mechanism is operated to inject the fluid around the rectifying body. Therefore, the periphery of the rectifying body can be heated.

A rectifying device according to a sixth aspect of the present invention is the rectifying device according to any one of the first to fifth aspects of the present invention, in which the heating mechanism is operated in a case in which an air temperature outside of the vehicle is lower than or equal to a first temperature.

In the rectifying device of the sixth aspect of the present invention, the heating mechanism is operated in a case in which the air temperature outside of the vehicle is lower than or equal to the first temperature. Therefore, in a case in which the air temperature outside of the vehicle is lower than or equal to the first temperature, the periphery of the rectifying body can be heated.

A rectifying device according to a seventh aspect of the present invention includes, in the rectifying device according to any one of the first to sixth aspects of the present invention, a drive mechanism that drives the rectifying body, in which the heating mechanism is operated in a case in which a temperature of the drive mechanism is lower than or equal to a second temperature.

In the rectifying device of the seventh aspect of the present invention, the drive mechanism drives the rectifying body.

Here, in a case in which the temperature of the drive mechanism is lower than or equal to the second temperature, the heating mechanism is operated. Therefore, in a case in which the temperature of the drive mechanism is lower than or equal to the second temperature, the periphery of the rectifying body can be heated.

A rectifying device according to an eighth aspect of the present invention is the rectifying device according to any one of the first to seventh aspects of the present invention, in which the heating mechanism is operated in a case in which there is an abnormality in movement of the rectifying body.

In the rectifying device of the eighth aspect of the present invention, the heating mechanism is operated in a case in which there is an abnormality in the movement of the rectifying body. Therefore, in a case in which there is an abnormality in the movement of the rectifying body, the periphery of the rectifying body can be heated.

### BRIEF DESCRIPTION OF THE DRAWINGS

Exemplary embodiments of the present invention will be described in detail based on the following figures, wherein:

FIG. 1 is a side view illustrating a front portion of a vehicle in an embodiment of the present invention as viewed from an outside in a vehicle width direction; and

FIG. 2 is a perspective view illustrating a rectifying device according to the embodiment of the present invention as viewed from a vehicle front side and from the outside in the vehicle width direction.

### DETAILED DESCRIPTION

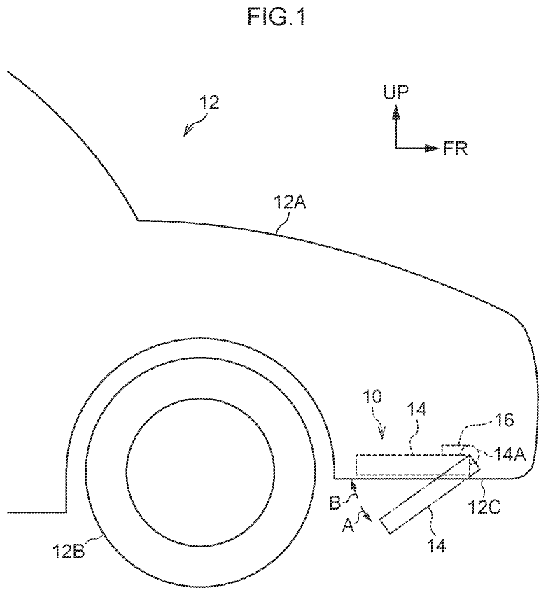

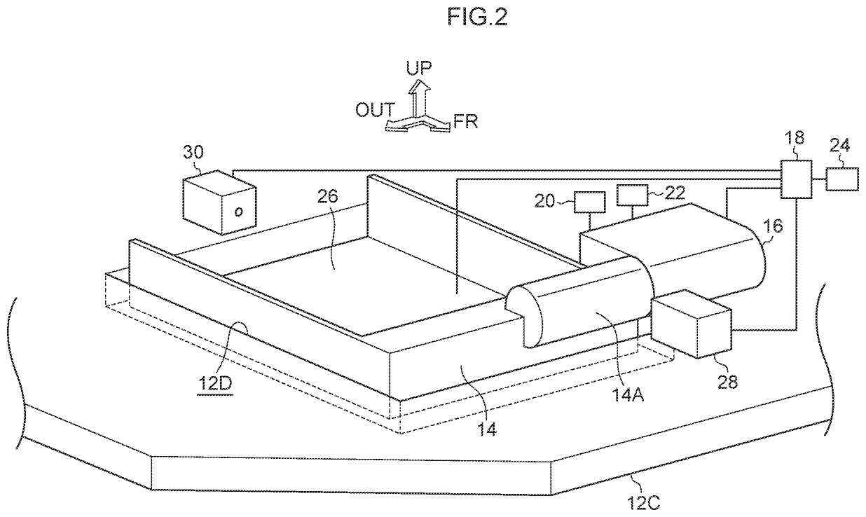

FIG. 1 is a side view of a front portion of a vehicle 12 in an embodiment of the present invention as viewed from an outside in a vehicle width direction (a right side of the vehicle), and FIG. 2 is a perspective view of a rectifying device 10 according to the present embodiment as viewed from a vehicle front side and from the outside in the vehicle width direction. Note that, in the drawings, the vehicle front side is indicated by an arrow FR, the outside in the vehicle width direction is indicated by an arrow OUT, and the upper side is indicated by an arrow UP.

As illustrated in FIG. 1, the rectifying device 10 according to the present embodiment is installed in a front end portion of a vehicle body 12A and is disposed on a front side of the front wheel 12B of the vehicle 12. A lower surface (bottom surface) of the vehicle body 12A is covered with a plate-shaped undercover 12C (see FIG. 2) as a covering member, and a rectangular deployment hole 12D is formed through the undercover 12C on a lower side of the rectifying device 10.

As illustrated in FIGS. 1 and 2, the rectifying device 10 is provided with a substantially rectangular parallelepiped box-shaped deflector 14 made of resin as a rectifying body, and an inside of the deflector 14 is opened to an upper side and a vehicle rear side. A cylindrical rotation shaft 14A is integrally provided at a vehicle front side end portion of the deflector 14, and the deflector 14 is rotatable (movable) about the rotation shaft 14A in a deployment direction A and a housing direction B (see FIG. 1), The deflector 14 is disposed at a housing position (dashed line position in FIG. 1, position in FIG. 2), and the deflector 14 is housed in the vehicle body 12A (the deployment hole 12D of the undercover 12C) and does not protrude to the lower side of the vehicle body 12A (the lower side of the undercover 12C). The deflector 14 is rotated in the deployment direction A and can be disposed at a deployment position (position indicated by a two-dot chain line in FIG. 1), whereby the deflector 14 protrudes from the deployment hole 12D to the lower side of the vehicle body 12A. Furthermore, the deflector 14 is rotated in the housing direction B from the deployment position, and is disposed (returned) to the housing position.

An actuator 16 as a drive mechanism is mechanically connected to an inside of the rotation shaft 14A of the deflector 14 in the vehicle width direction, and the actuator 16 is fixed to an upper side of the undercover 12C (in the vehicle body 12A) to support the deflector 14. An ECU of the actuator 16 is electrically connected to a control device 18 of the vehicle 12, and the actuator 16 is operated to rotate (drive) the deflector 14 under the control of the control device 18.

The actuator 16 is provided with a temperature detection device 20, and the temperature detection device 20 detects a temperature in the actuator 16 (a temperature of the ECU). The actuator 16 is provided with a rotation detection device 22 (movement detection device), and the rotation detection device 22 detects the rotation (rotation position, rotation speed, etc.) of the deflector 14. The temperature detection device 20 and the rotation detection device 22 are electrically connected to the control device 18. An air temperature detection device 24 is electrically connected to the control device 18, and the air temperature detection device 24 detects an air temperature outside of the vehicle body 12A.

A sheet-like heater 26 as a heating mechanism is fixed (attached) to an entire inner peripheral surface (inner lower surface, vehicle front side surface, and both side surfaces in the vehicle width direction) of the deflector 14, and the heater 26 is provided with an electric heating wire (not illustrated) as a whole. The heater 26 (electric heating wire) is electrically connected to the control device 18, and the heater 26 (electric heating wire) is operated (energized) and generates heat under the control of the control device 18.

A front injection device 28 as a heating mechanism (injection device) is fixed to an upper surface of the undercover 12C in the vicinity of the vehicle front side of an inner end portion in the vehicle width direction of the deployment hole 12D. The front injection device 28 is electrically connected to the control device 18, and the front injection device 28 is operated by the control of the control device 18 to inject hot water (heated water) as a fluid between the inner surface of the deflector 14 in the vehicle width direction and the inner surface of the deployment hole 12D in the vehicle width direction (including between sliding contact surfaces of the rotation shaft 14A of the deflector 14 and the actuator 16).

A rear injection device 30 as a heating mechanism (injection device) is fixed to the upper surface of the undercover 12C in the vicinity of the vehicle rear side of a central portion in the vehicle width direction of the deployment hole 12D. The rear injection device 30 is electrically connected to the control device 18, and the rear injection device 30 is operated by the control of the control device 18 to inject hot water to the center portion in the vehicle width direction between the vehicle rear side end of the deflector 14 and the vehicle rear side surface of the deployment hole 12D.

Next, the operation of the present embodiment will be described.

In the rectifying device 10 having the above configuration, the deflector 14 is disposed at the housing position, and is housed in the deployment hole 12D of the undercover 12C.

When the vehicle 12 travels at a high speed, the actuator 16 is operated by the control of the control device 18 to rotate the deflector 14 in the deployment direction A, so that the deflector 14 is disposed at the deployment position and protrudes downward from the deployment hole 12D of the undercover 12C. Therefore, the deflector 14 is disposed on the vehicle front side of the front wheel 12B below the vehicle body 12A to suppress traveling wind (air flow) of the vehicle 12 toward the front wheel 12B (to flow the traveling wind to the lower side of the front wheel 12B), so that the increase in the air pressure on the vehicle front side of the front wheel 12B is suppressed, and the air resistance and the lift of the vehicle 12 are suppressed.

Thereafter, when the vehicle 12 travels at a low speed, the actuator 16 is operated by the control of the control device 18 to rotate the deflector 14 in the housing direction B, so that the deflector 14 is disposed at the housing position and housed in the deployment hole 12D of the undercover 12C.

By the way, the deflector 14 is disposed near the front wheel 12B of the vehicle 12. Therefore, when the vehicle 12 travels in a cold district, there is a possibility that a space (that is around the deflector 14 and includes a space between sliding contact surfaces of the rotation shaft 14A of the deflector 14 and the actuator 16) between the deflector 14 and a peripheral surface of the deployment hole 12D of the undercover 12C is frozen by snow or ice.

Here, when at least one of an air temperature outside of the vehicle body 12A an air temperature detected by the air temperature detection device 24) is lower than or equal to a first temperature (for example, 5°) or a temperature inside the actuator 16 (a temperature detected by the temperature detection device 20) is lower than or equal to a second temperature (for example, 5°), in a case in which even if the control device 18 operates the actuator 16, the deflector 14 is not rotated in the deployment direction A (the rotation detection device 22 does not detect the rotation of the deflector 14 in the deployment direction A), the heater 26 on the inner peripheral surface of the deflector 14 is operated by the control of the control device 18 to generate heat, and the front injection device 28 and the rear injection device 30 on the undercover 12C are operated to inject hot water between the deflector 14 and the peripheral surface of the deployment hole 12D of the undercover 12C.

Therefore, the heater 26 generates heat to heat the deflector 14, so that the space between the deflector 14 and the peripheral surface of the deployment hole 12D is heated. Moreover, the front injection device 28 and the rear injection device 30 inject hot water between the deflector 14 and the peripheral surface of the deployment hole 12D, so that a space between the deflector 14 and the peripheral surface of the deployment hole 12D (including a space between sliding contact surfaces of the rotation shaft 14A of the deflector 14 and the actuator 16) is heated. As a result, it is possible to melt the freezing between the deflector 14 and the peripheral surface of the deployment hole 12D (including between the sliding contact surfaces of the rotation shaft 14A of the deflector 14 and the actuator 16), and the deflector 14 can be rotated in the deployment direction A by the operation of the actuator 16.

Furthermore, when at least one of the air temperature outside of the vehicle body 12A (the air temperature detected by the air temperature detection device 24) is lower than or equal to the first temperature or the temperature inside the actuator 16 (the temperature detected by the temperature detection device 20) is lower than or equal to the second temperature, in a case in which even if the control device 18 operates the actuator 16, a rotation speed of the deflector 14 in the deployment direction A (a rotation speed of the deflector 14 in the deployment direction A detected by the rotation detection device 22) is lower than a set speed, the front injection device 28 and the rear injection device 30 are operated by the control of the control device 18 to inject hot water between the deflector 14 and the peripheral surface of the deployment hole 121) of the undercover 12C (including between the sliding contact surfaces of the rotation shaft 14A of the deflector 14 and the actuator 16). As a result, it is possible to melt the freezing between the deflector 14 and the peripheral surface of the deployment hole 12D (including between the sliding contact surfaces of the rotation shaft 14A of the deflector 14 and the actuator 16), and the deflector 14 can be appropriately rotated in the deployment direction A by the operation of the actuator 16.

Moreover, as described above, even when a space between the deflector 14 and the peripheral surface of the deployment hole 12D (including a space between the sliding contact surfaces of the rotation shaft 14A of the deflector 14 and the actuator 16) is frozen, the freezing can be melted by at least one of the heater 26, the front injection device 28, or the rear injection device 30. Therefore, the rotational resistance of the deflector 14 can be reduced, and a decrease in the life of the actuator 16 (for example, a motor) that rotates the deflector 14 can be suppressed. In addition, it is possible to suppress deterioration of physical properties of the deflector 14 due to freezing of the deflector 14, and it is possible to suppress breakage of the deflector 14.

Furthermore, as described above, even if at least one of the heater 26, the front injection device 28, or the rear injection device 30 is operated for a predetermined time or more, it can be determined that the actuator 16 has failed in a case in which the rotational speed of the deflector 14 in the deployment direction A (the rotational speed of the deflector 14 in the deployment direction A detected by the rotation detection device 22) is lower than the set speed (including a case in which the deflector 14 is not rotated in the deployment direction A).

Note that, in the present embodiment, the heater 26 is provided on the inner peripheral surface of the deflector 14. However, the heater 26 may be provided on an outer peripheral surface of the deflector 14.

Furthermore, in the present embodiment, the heater 26 is provided in the deflector 14 to heat the deflector 14. However, the heater 26 may be provided on the undercover 12C (including a peripheral surface of the deployment hole 12D) to heat the undercover 12C.

Moreover, in the present embodiment, the front injection device 28 and the rear injection device 30 inject hot water. However, the front injection device 28 and the rear injection device 30 may inject fluid (liquid (particularly water) or gas (particularly air)) that is heated or not heated.

Furthermore, in the present embodiment, when as least one of the air temperature outside of the vehicle body 12A (the air temperature detected by the air temperature detection device 24) is lower than or equal to the first temperature or the temperature inside the actuator 16 (the temperature detected by the temperature detection device 20) is lower than or equal to the second temperature, in a case in which even if the control device 18 operates the actuator 16, the rotation speed of the deflector 14 in the deployment direction A (the rotation speed of the deflector 14 in the deployment direction A detected by the rotation detection device 22) is lower than the set speed (including a case in which the deflector 14 is not rotated in the deployment direction A), at least one of the heater 26, the front injection device 28, or the rear injection device 30 is operated.

However, when at least one of the air temperature outside of the vehicle body 12A (the air temperature detected by the air temperature detection device 24) is lower than or equal to the first temperature or the temperature in the actuator 16 (the temperature detected by the temperature detection device 20) is lower than or equal to the second temperature, in a case in which even if the control device 18 operates the actuator 16, the rotation speed of the deflector 14 in the housing direction B (the rotation speed of the deflector 14 in the housing direction B detected by the rotation detection device 22) is lower than the set speed (including a case in which the deflector 14 is not rotated in the housing direction B), at least one of the heater 26, the front injection device 28, or the rear injection device 30 may be operated.

Moreover, when at least one of the air temperature outside of the vehicle body 12A (the air temperature detected 1w the air temperature detection device 24) is lower than or equal to the first temperature or the temperature in the actuator 16 (the temperature detected by the temperature detection device 20) is lower than or equal to the second temperature, in a case in which the ignition of the vehicle 12 is turned ON, at least one of the heater 26, the front injection device 28, or the rear injection device 30 may be operated.

In addition, in at least one case of a case in which the air temperature outside of the vehicle body 12A (the air temperature detected by the air temperature detection device 24) is lower than or equal to the first temperature, a case in which the temperature inside the actuator 16 (the temperature detected by the temperature detection device 20) is lower than or equal to the second temperature, a case in which even if the control device 18 operates the actuator 16, the rotation speed of the deflector 14 (the rotation speed of the deflector 14 detected by the rotation detection device 22) is lower than the set speed (including a case in which the deflector 14 is not rotated), or a case in which the ignition of the vehicle 12 is turned ON, at least one of the heater 26, the front injection device 28, or the rear injection device 30 may be operated.

What is claimed is:

1. A rectifying device comprising:
a rectifying body that is moved in a deployment direction to be deployed on a front side of a front wheel of a vehicle, to suppress an air flow to the front wheel, and that is moved in a housing direction to be housed in a vehicle body; and
a heating mechanism that is operated to heat a periphery of the rectifying body.

2. The rectifying device according to claim 1, wherein the heating mechanism is operated to heat the rectifying body.

3. The rectifying device according to claim 1, further comprising a covering member that covers a lower side of the vehicle body, that is provided with a deployment hole from which the rectifying body is deployed, and the heating mechanism being operated to heat between the rectifying body and a peripheral surface of the deployment hole.

4. The rectifying device according to claim 3, wherein the heating mechanism is operated to heat the covering member.

5. The rectifying device according to claim 1, wherein the heating mechanism is operated to inject a fluid around the rectifying body.

6. The rectifying device according to claim 1, wherein the heating mechanism is operated in a case in which an air temperature outside of the vehicle is lower than or equal to a first temperature.

7. The rectifying device according to claim 1, further comprising a drive mechanism that drives the rectifying body, wherein the heating mechanism is operated in a case in which a temperature of the drive mechanism is lower than or equal to a second temperature.

8. The rectifying device according to claim 1, wherein the heating mechanism is operated in a case in which there is an abnormality in movement of the rectifying body.

9. The rectifying device according to claim 8, wherein the heating mechanism is operated in a case in which a speed of the rectifying body is lower than a set speed.

10. The rectifying device according to claim 1, wherein the heating mechanism is operated in a case in which an ignition of the vehicle is turned ON.
